(19) United States
(12) Patent Application Publication
(10) Pub. No.: US 2002/0110405 A1
(43) Pub. Date: Aug. 15, 2002

(54) Tool for binders

(76) Inventor: Terri Marshall, Inglewood, CA (US)

Correspondence Address: Richard W. Goldstein, 2071 Clove Road, Staten Island, NY, 10304, US

(21) Appl. No.: 09/780,417

(22) Filed: Feb. 9, 2001

(51) Int. Cl. B42F 13/00

(52) U.S. Cl. 402/73

(57) ABSTRACT

A title page and insertion tool for binders including a title page having a generally rectangular configuration. The title page is dimensioned for being received within a clear pocket on a spine of a binder. A pulley is provided having a generally rectangular configuration. The pulley has a front surface, a rear surface, opposed short upper and lower ends and opposed long side edges. The front and rear surfaces of the upper and lower ends of the pulley each have an adhesive layer disposed thereon. Each adhesive layer has a protective covering removably disposed thereover.

### BACKGROUND OF THE INVENTION

The present invention relates to a title page and insertion tool for binders and more particularly pertains to allowing for simple insertion of a title page into a pocket of a binder.

Presently, most store purchased binders are provided with a clear pocket on the spine to allow for the purchaser to insert a piece of paper or the like in order to easily identify the contents of the binder without actually having to open it for further inspection. Usually, most people will attempt to slide the piece of paper into the clear pocket resulting in the excessive wrinkling or even tearing of the piece of paper. Often, even if the person is successful in maneuvering the piece of paper into the clear pocket, the paper can sometimes come dislodged from the pocket necessitating the repeating of the procedure.

The present invention seeks a solution to this problem by providing a semi-rigid title page with adhesive on both sides and both ends thereof to facilitate securement within the pocket. Additionally, the present invention provides a semi-rigid pulley that will allow for the title page to be drawn into the pocket without wrinkling or tearing.

The use of notebook covers is known in the prior art. More specifically, notebook covers heretofore devised and utilized for the purpose of displaying graphics or other writings are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,209,624 to Nicolaisen discloses a sheet with an adhesive layer used as a stiffening plate with a book cover. The Nicolaisen device is used for paperback books. U.S. Pat. No. 5,620,207 to Podoskek discloses the use of a stiffener insert panel for constructing binders. U.S. Pat. No. 5,671,950 to Hanson discloses a cover pocket and insert for use with a binder.

While these devices fulfill their respective, particular objective and requirements, the aforementioned patents do not describe a title page and insertion tool for binders for allowing for simple insertion of a title page into a pocket of a binder.

In this respect, the title page and insertion tool for binders according to the present invention substantially departs from the conventional concepts and designs of the prior art, and in doing so provides an apparatus primarily developed for the purpose of allowing for simple insertion of a title page into a pocket of a binder.

Therefore, it can be appreciated that there exists a continuing need for new and improved title page and insertion tool for binders which can be used for allowing for simple insertion of a title page into a pocket of a binder. In this regard, the present invention substantially fulfills this need.

### SUMMARY OF THE INVENTION

In the view of the foregoing disadvantages inherent in the known types of notebook covers now present in the prior art, the present invention provides an improved title page and insertion tool for binders. As such, the general purpose of the present invention, which will be described subsequently in greater detail, is to provide a new and improved title page and insertion tool for binders and method which has all the advantages of the prior art and none of the disadvantages.

To attain this, the present invention essentially comprises a binder having a cover portion, a back portion, and a spine disposed therebetween. The spine has a clear pocket disposed thereon. The clear pocket has open upper and lower ends. A title page is provided having a generally rectangular configuration. The title page is dimensioned for being received within the clear pocket of the binder. The title page is constructed of a semi-rigid material. The title page has a front surface, a rear surface, opposed short upper and lower ends and opposed long side edges. A pulley is provided having a generally rectangular configuration. The pulley is constructed of a semi-rigid material. The pulley has a front surface, a rear surface, opposed short upper and lower ends and opposed long side edges. The front and rear surfaces of the upper and lower ends of the pulley each have an adhesive layer disposed thereon. Each adhesive layer has a protective covering removably disposed thereover.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved title page and insertion tool for binders which has all the advantages of the prior art notebook covers and none of the disadvantages.

It is another object of the present invention to provide a new and improved title page and insertion tool for binders which may be easily and efficiently manufactured and marketed.

It is a further object of the present invention to provide a new and improved title page and insertion tool for binders which is of durable and reliable construction.

An even further object of the present invention is to provide a new and improved title page and insertion tool for binders which is susceptible of a low cost of manufacture with regard to both materials and labor, and which accordingly is then susceptible of low prices of sale to the consuming public, thereby making such a title page and insertion tool for binders economically available to the buying public.

Even still another object of the present invention is to provide a new and improved title page and insertion tool for binders for allowing for simple insertion of a title page into a pocket of a binder.

Lastly, it is an object of the present invention to provide a new and improved title page and insertion tool for binders including a title page having a generally rectangular configuration. The title page is dimensioned for being received within a clear pocket on a spine of a binder. A pulley is provided having a generally rectangular configuration. The pulley has a front surface, a rear surface, opposed short upper and lower ends and opposed long side edges. The front and rear surfaces of the upper and lower ends of the pulley each have an adhesive layer disposed thereon. Each adhesive layer has a protective covering removably disposed thereover.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the title page and insertion tool for binders constructed in accordance with the principles of the present invention.

FIG. 2 is a perspective view of the pulley of the present invention illustrated with adhesive covers in place.

FIG. 3 is a front view of the pulley of the present invention illustrated with the adhesive covers removed therefrom.

FIG. 4 is a side view of the pulley of the present invention as taken along line 4-4 of FIG. 3.

The same reference numerals refer to the same parts through the various figures.

### DESCRIPTION OF THE PREFERRED EMBODIMENT

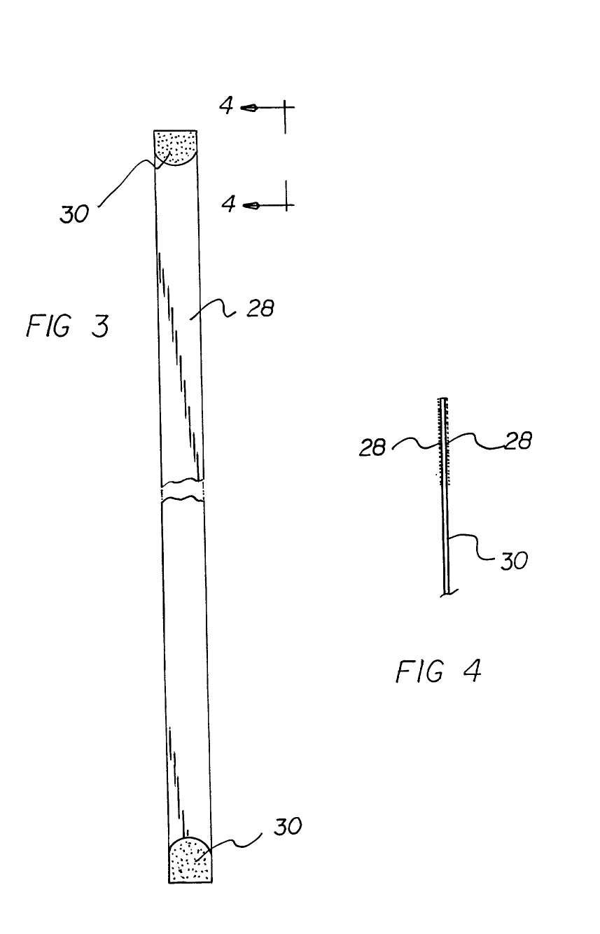

With reference now to the drawings, and in particular, to FIGS. 1 through 4 thereof, the preferred embodiment of the new and improved title page and insertion tool for binders embodying the principles and concepts of the present invention and generally designated by the reference number 10 will be described.

Specifically, it will be noted in the various Figures that the device relates to a title page and insertion tool for binders for allowing for simple insertion of a title page into a pocket of a binder. In its broadest context, the device consists of a binder, a title page, and a pulley. Such components are individually configured and correlated with respect to each other so as to attain the desired objective.

FIG. 1 illustrates the binder 12. The binder 12 has a cover portion 14, a back portion 16, and a spine 18 disposed therebetween. The spine 18 has a clear pocket 20 disposed thereon. The clear pocket 20 has open upper and lower ends 22, 24.

The title page 26 has a generally rectangular configuration. The title page 26 is dimensioned for being received within the clear pocket 20 of the binder 12. Note FIG. 1. The title page 26 is constructed of a semi-rigid material. This will prevent excessive wrinkling or tearing. The title page 26 has a front surface, a rear surface, opposed short upper and lower ends and opposed long side edges.

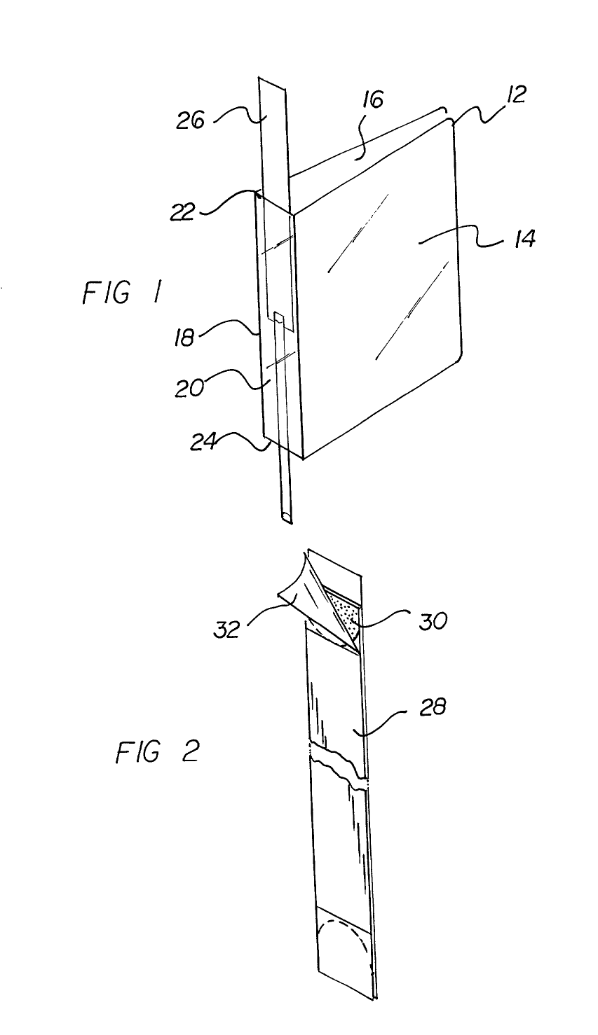

The pulley 28 has a generally rectangular configuration. Note FIGS. 2-4. The pulley 28 is constructed of a semi-rigid material, similar to the title page 26. The pulley 28 has a front surface, a rear surface, opposed short upper and lower ends and opposed long side edges. The front and rear surfaces of the upper and lower ends of the pulley each have an adhesive layer 30 disposed thereon. Each adhesive layer 30 has a protective covering 32 removably disposed thereover.

In use, the pulley 28 is first inserted into the open lower end 24 of the clear pocket 20, and is pushed upward to loosen the pocket. As one end of the pulley 28 emerges from the open upper end 24 of the clear pocket 20, the pulley 28 is then attached to the title page 26 leaving a ¼ inch overlap at the bottom. The protective coverings 32 is then removed from the adhesive layer 30 at the end that emerges from the clear plastic window 20, and said adhesive layer is attached to the title page 26 at its upper end. Then, the pulley is pulled upwardly through the clear plastic window 20 whereupon the upper end of the title page 26 is pulled upwardly through the clear pocket 20. Once the title page 26 is in place, and the lower end of the pulley substantially emerges from the open upper end 24 of the clear plastic window 20, the user grasps the title page 26 and holds firmly to remove the pulley 28 by releasing the adhesive layer 30.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A title page and insertion tool for binders for allowing for simple insertion of a title page into a pocket of a binder comprising, in combination:
a binder having a cover portion, a back portion, and a spine disposed therebetween, the spine having a clear pocket disposed thereon, the clear pocket having open upper and lower ends;
a title page having a generally rectangular configuration, the title page being dimensioned for being received within the clear pocket of the binder, the title page being constructed of a semi-rigid material, the title page having a front surface, a rear surface, opposed short upper and lower ends and opposed long side edges;
a pulley having a generally rectangular configuration, the pulley being constructed of a semi-rigid material, the pulley having a front surface, a rear surface, opposed short upper and lower ends and opposed long side edges, the front and rear surfaces of the upper and lower ends of the pulley each having an adhesive layer disposed thereon, each adhesive layer having a protective covering removably disposed thereover.

2. A title page and insertion tool for binders for allowing for simple insertion of a title page into a pocket of a binder comprising, in combination:
a title page having a generally rectangular configuration, the title page being dimensioned for being received within a clear pocket on a spine of a binder;
a pulley having a generally rectangular configuration, the pulley having a front surface, a rear surface, opposed short upper and lower ends and opposed long side edges, the front and rear surfaces of the upper and lower ends of the pulley each having an adhesive layer disposed thereon, each adhesive layer having a protective covering removably disposed thereover.

3. The title page and insert tool for binders as set forth in claim 2 wherein the title page and the pulley are each constructed of a semi-rigid material.

4. A title page insertion method, for inserting a title page into a binder having a spine having a clear plastic window having an open upper end and an open lower end, the title page having a generally rectangular configuration and sized for fitting inside the clear plastic window between the open upper end and open lower end, comprising the steps of:
a) providing a pulley, the pulley being a strip made of semi-rigid material having, the pulley having a front surface, a rear surface, opposed short upper and lower ends and opposed long side edges, the front and rear surfaces of the upper and lower ends of the pulley each having an adhesive layer disposed thereon, each adhesive layer having a protective covering removably disposed thereover;
b) inserting the lower end of the pulley into the open upper end of the clear plastic window;
c) loosening the clear plastic window by pushing the pulley downward through the clear plastic window until it emerges from the open lower end of said clear plastic window.
d) removing one of the protective coverings from the one of the adhesive layers which emerges from the open lower end of the binder window;
e) attaching said adhesive layer onto the title page;
f) pulling the pulley upward, pulling the title page into the clear plastic window, until the pulley substantially emerges from the open upper end of the binder window; and
g) removing the pulley from the title page by releasing the adhesive from the title page.
